(19) United States
(12) Patent Application Publication
(10) Pub. No.: US 2026/0157278 A1
(43) Pub. Date: Jun. 11, 2026

(54) PUSH LAWNMOWER WITH COMB

(71) Applicant: Robert J. Flageolle, SR., North Glenn, CO (US)

(72) Inventor: Robert J. Flageolle, SR., North Glenn, CO (US)

(21) Appl. No.: 18/973,881

(22) Filed: Dec. 9, 2024

(51) Int. Cl. A01D 43/02; A01D 101/00

(52) U.S. Cl. CPC A01D 43/02; A01D 2101/00

(57) ABSTRACT

A push lawnmower includes a lawnmower deck. The lawnmower deck includes a central deck portion, a front deck portion projecting from the central deck portion, and a rear deck portion projecting from the central deck portion. The front deck portion includes a top panel and a pair of side panels extending downwardly from the top panel. A toothed comb is connected to the top panel of the front deck portion. The toothed comb is positioned to extend downwardly from the top panel and between the side panels to straighten grass prior to cutting by the lawnmower blade. An engine is mounted on the top wall of the central deck portion and a lawnmower blade is connected to the engine. The push lawnmower includes a pair of front wheels, a pair of rear wheels, and a handle assembly.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to lawnmowers and more particularly pertains to a new push lawnmower for improved cutting of grass. Push lawnmowers have a deck with a lower edge for protecting against access to the blades and to guide the cut grass. However, the deck does not brush or comb the grass to straighten the grass for optimal cutting. The new push lawnmower includes a toothed comb that rakes the grass for better cutting.

(2) Description of Related Art Including Information Disclosed Under 37 CFR 1.97 and 1.98

The prior art relates to lawnmowers and similar tools, some of which include brush type elements for brushing grass. The prior art, as best understood, does not disclose a push lawnmower that has a front deck portion and a toothed comb that is connected to the front deck portion, wherein the toothed comb straightens grass prior to cutting by the lawnmower blade.

### (h) BRIEF SUMMARY OF THE INVENTION

An embodiment of the disclosure meets the needs presented above in a push lawnmower generally comprising a lawnmower deck. The lawnmower deck includes a central deck portion, a front deck portion projecting from the central deck portion, and a rear deck portion projecting from the central deck portion. The central deck portion includes a top wall. The central deck portion includes a perimeter wall extending downwardly from the top wall. The perimeter wall is designed to extend around a lawnmower blade. The front deck portion includes a top panel and a pair of side panels extending downwardly from the top panel. The top panel is connected to the top wall of the central deck portion. The pair of side panels is connected to the perimeter wall of the central deck portion. A toothed comb is connected to the top panel of the front deck portion. The toothed comb is positioned to extend downwardly from the top panel and between the side panels to straighten grass prior to cutting by the lawnmower blade. An engine is mounted on the top wall of the central deck portion. A lawnmower blade is connected to the engine and positioned under the top wall of the central deck portion. The push lawnmower includes a pair of front wheels, a pair of rear wheels, and a handle assembly. Each of the pair of front wheels is rotatably mounted to a respective one of the side panels of the front deck portion. The pair of rear wheels is rotatably mounted to the rear deck portion. The handle assembly is connected to and projects upwardly from the lawnmower deck.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a push lawnmower according to an embodiment of the disclosure.

FIG. 2 is a close-up view of a portion of an embodiment of the disclosure.

FIG. 3 is a close-up view of a portion of an embodiment of the disclosure.

FIG. 4 is a front view of an embodiment of the disclosure.

FIG. 5 is a side view of an embodiment of the disclosure.

### (i) DETAILED DESCRIPTION OF THE INVENTION

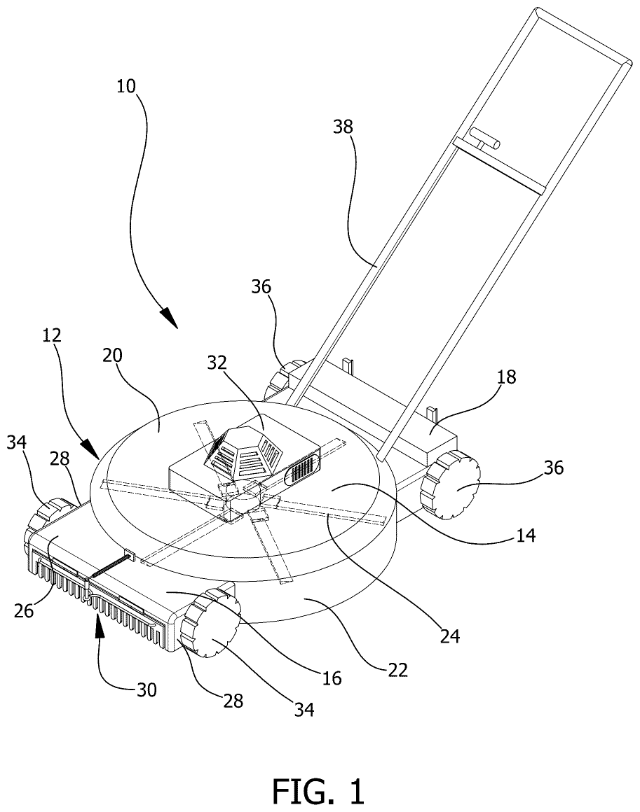

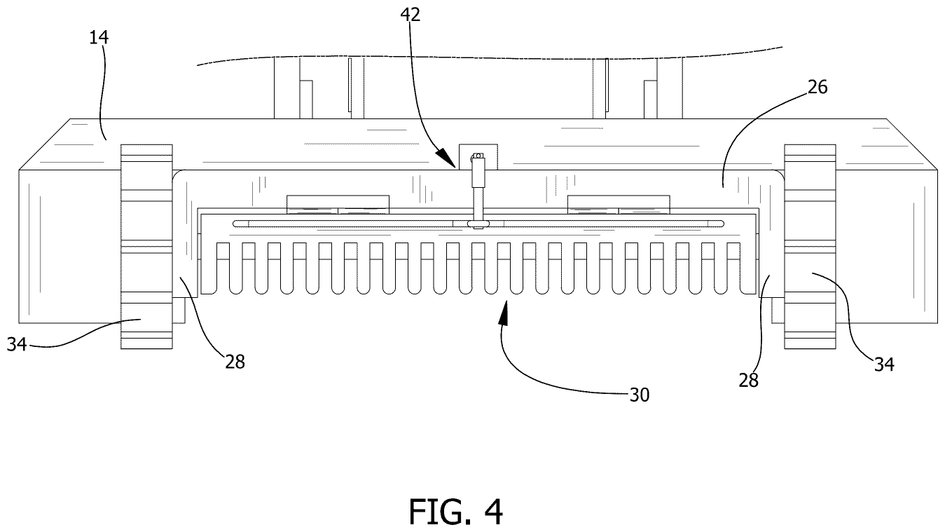

With reference now to the drawings, and in particular to FIGS. 1 through 5 thereof, a new push lawnmower embodying the principles and concepts of an embodiment of the disclosure and generally designated by the reference numeral 10 will be described.

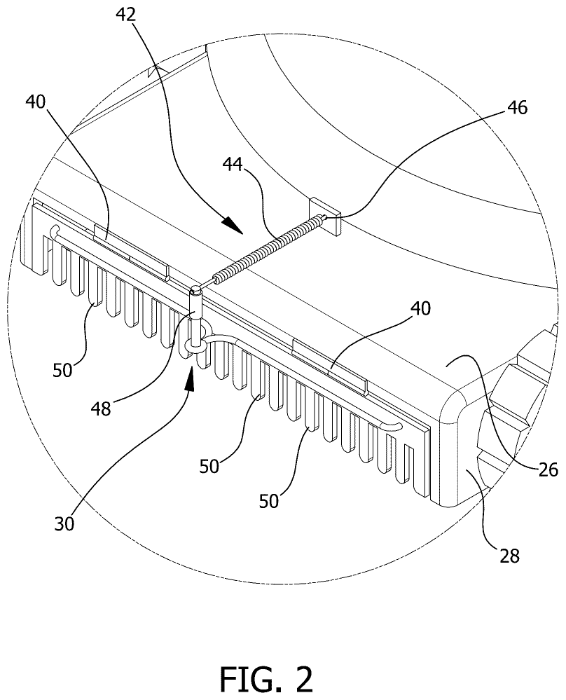

As best illustrated in FIGS. 1 through 5, the push lawnmower 10 generally comprises a lawnmower deck 12. As shown in FIG. 1, the lawnmower deck 12 includes a central deck portion 14, a front deck portion 16 projecting from the central deck portion 14, and a rear deck portion 18 projecting from the central deck portion 14. The central deck portion 14 includes a top wall 20. The central deck portion 14 includes a perimeter wall 22 extending downwardly from the top wall 20. The perimeter wall 22 is designed to extend around a lawnmower blade 24. The front deck portion 16 includes a top panel 26 and a pair of side panels 28 extending downwardly from the top panel 26. The top panel 26 is connected to the top wall 20 of the central deck portion 14. The pair of side panels 28 is connected to the perimeter wall 22 of the central deck portion 14. A toothed comb 30 is connected to the top panel 26 of the front deck portion 16. As best seen in FIG. 2, the toothed comb 30 is positioned to extend downwardly from the top panel 26 and between the side panels 28 to straighten grass prior to cutting by the lawnmower blade 24. As shown in FIG. 1, an engine 32 is mounted on the top wall 20 of the central deck portion 14. A lawnmower blade 24 is connected to the engine 32 and positioned under the top wall 20 of the central deck portion 14. The push lawnmower 10 includes a pair of front wheels 34, a pair of rear wheels 36, and a handle assembly 38. Each of the pair of front wheels 34 is rotatably mounted to a respective one of the side panels 28 of the front deck portion 16. The pair of rear wheels 36 is rotatably mounted to the rear deck portion 18. The handle assembly 38 is connected to and projects upwardly from the lawnmower deck 12.

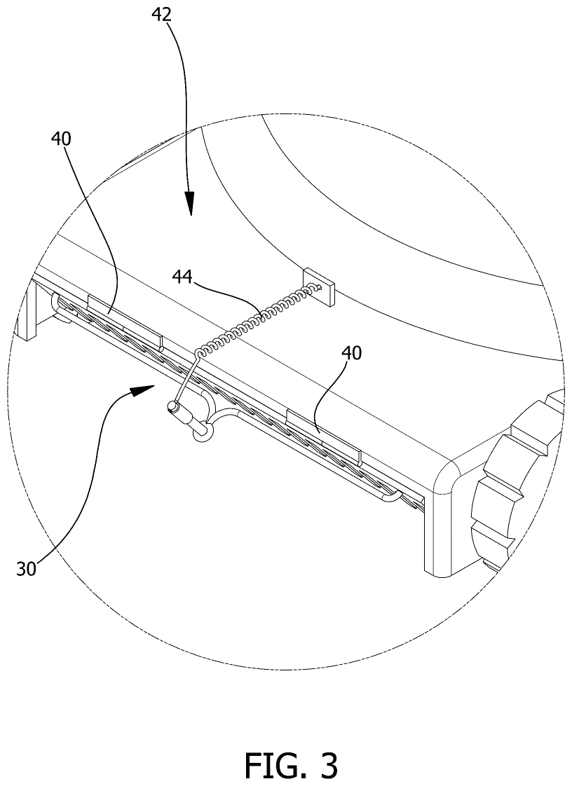

As shown in the exemplary embodiment in FIGS. 2 and 3, the push lawnmower 10 further includes a hinge 40, or a pair of the hinges 40 as shown in the exemplary embodiment, pivotably connecting the toothed comb 30 to the top panel 26 of the front deck portion 16. The toothed comb 30 is designed to pivot inwardly under the top panel 26. In the exemplary embodiment, a spring assembly 42 is connected to the toothed comb 30 to bias the toothed comb 30 forward in a direction away from the central deck portion 14. The spring assembly 42 is designed to provide sufficient force to resist movement of the toothed comb 30 by contact with the grass and insufficient force to resist movement of the toothed comb 30 by contact with ground. In the exemplary embodiment, the spring assembly 42 includes a spring 44 attached to a bracket 46. A coupler 48 connects the spring 44 to the toothed comb 30. When the toothed comb 30 is pivoted inwardly as in FIG. 3, the spring 44 stretches, wherein the spring 44 will exert a return force when the force being exerted to move the toothed comb 30 is released. The spring assembly 42 shown in FIGS. 2 and 3 is one possible embodiment, as other return systems could be used, such as coiled pivot pins connected to the hinges 40.

In the exemplary embodiment, the toothed comb 30 includes a plurality of rigid teeth 50. The toothed comb 30 is designed much like a dirt rake, as opposed to a more flexible leaf rake.

While an entire push lawnmower 10 is shown in the figures, the lawnmower deck 12 with the toothed comb 30 could be manufactured and installed by itself on different types of mowers, such as gas and electric mowers.

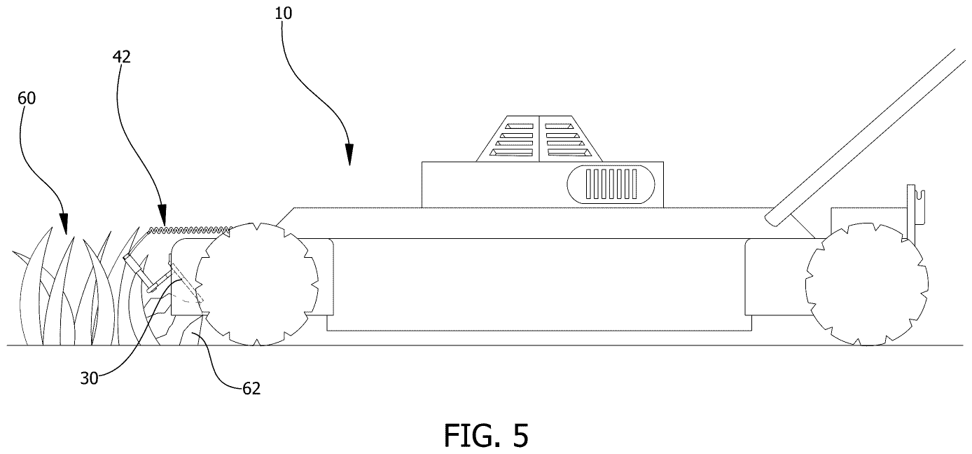

In use, the toothed comb 30 will contact grass 60 and cause the grass blades to stand more vertically to improve the cutting effect of the lawnmower blade 24. The toothed comb 30 will also serve to push away debris, like small rocks and branches. If the toothed comb 30 is pushed against an object that resists pushing, such as uneven ground or a larger rock 62 embedded in the ground, as shown in FIG. 5, the toothed comb 30 can pivot inwardly to prevent damage to the toothed comb 30 or the lawnmower.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A push lawnmower comprising:
a lawnmower deck including:
a central deck portion, said central deck portion including a top wall, said central deck portion including a perimeter wall extending downwardly from said top wall, said perimeter wall being configured to extend around a lawnmower blade;
a front deck portion projecting from said central deck portion, said front deck portion including a top panel and a pair of side panels extending downwardly from said top panel, said top panel being connected to said top wall of said central deck portion, said pair of side panels being connected to said perimeter wall of said central deck portion; and
a toothed comb being connected to said top panel of said front deck portion, said toothed comb being positioned to extend downwardly from said top panel and between said side panels to straighten grass prior to cutting by the lawnmower blade; and
a rear deck portion projecting from said central deck portion;
an engine being mounted on said top wall of said central deck portion;
a lawnmower blade being connected to said engine and positioned under said top wall of said central deck portion;
a pair of front wheels, each of said pair of front wheels being rotatably mounted to a respective one of said side panels of said front deck portion;
a pair of rear wheels being rotatably mounted to said rear deck portion; and
a handle assembly being connected to and projecting upwardly from said lawnmower deck.

2. The push lawnmower of claim 1, further including:
a hinge pivotably connecting said toothed comb to said top panel of said front deck portion, said toothed comb being configured to pivot inwardly under said top panel; and
a spring assembly being connected to said toothed comb to bias said toothed comb forward in a direction away from said central deck portion, wherein said spring assembly is configured to provide sufficient force to resist movement of said toothed comb by contact with the grass and insufficient force to resist movement of said toothed comb by contact with ground.

3. The push lawnmower of claim 1, wherein said toothed comb includes a plurality of rigid teeth.

4. The push lawnmower of claim 2, wherein said toothed comb includes a plurality of rigid teeth.

5. A lawnmower deck comprising:
a central deck portion, said central deck portion including a top wall configured to support an engine, said central deck portion including a perimeter wall extending downwardly from said top wall, said perimeter wall being configured to extend around a lawnmower blade;
a front deck portion projecting from said central deck portion, said front deck portion including a top panel and a pair of side panels extending downwardly from said top panel, said top panel being connected to said top wall of said central deck portion, said pair of side panels being connected to said perimeter wall of said central deck portion; and
a toothed comb being connected to said top panel of said front deck portion, said toothed comb being positioned to extend downwardly from said top panel and between said side panels to straighten grass prior to cutting by the lawnmower blade.

6. The lawnmower deck of claim 5, further including:
a hinge pivotably connecting said toothed comb to said top panel of said front deck portion, said toothed comb being configured to pivot inwardly under said top panel; and
a spring assembly being connected to said toothed comb to bias said toothed comb forward in a direction away from said central deck portion, wherein said spring assembly is configured to provide sufficient force to resist movement of said toothed comb by contact with the grass and insufficient force to resist movement of said toothed comb by contact with ground.

7. The lawnmower deck of claim 6, wherein said toothed comb includes a plurality of rigid teeth.

8. The lawnmower deck of claim 7, wherein each of said side panels of said front deck portion is configured to support a respective one of a pair of front wheels.

9. The lawnmower deck of claim 8, further including a rear deck portion projecting from said central deck portion, said rear deck portion being configured to support a pair of rear wheels.

10. The lawnmower deck of claim 5, wherein said toothed comb includes a plurality of rigid teeth.

11. The lawnmower deck of claim 5, wherein each of said side panels of said front deck portion is configured to support a respective one of a pair of front wheels.

12. The lawnmower deck of claim 5, further including a rear deck portion projecting from said central deck portion, said rear deck portion being configured to support a pair of rear wheels.
